(19) United States
(12) Patent Application Publication
(10) Pub. No.: US 2024/0241078 A1
(43) Pub. Date: Jul. 18, 2024

(54) ION SENSOR AND METHOD FOR DETECTING SUBSTANCE BEING DETECTED

(71) Applicant: DENSO CORPORATION, Kariya-city (JP)

(72) Inventors: Kazuhisa NAKAGAWA, Kariya-city (JP); Yuhei Shimizu, Kariya-city (JP); Daisuke Kobayashi, Kariya-city (JP); Masashi Suzuki, Kariya-city (JP); Akira Nukazuka, Kariya-city (JP); Teppei Sakai, Kariya-city (JP); Kei Hayakawa, Kariya-city (JP); Kazuhiko Kano, Kariya-city (JP); Mana Asano, Kariya-city (JP)

(21) Appl. No.: 18/603,999

(22) Filed: Mar. 13, 2024

Related U.S. Application Data
(63) Continuation of application No. PCT/JP2022/032626, filed on Aug. 30, 2022.

(30) Foreign Application Priority Data
Sep. 16, 2021 (JP) 2021-151177

(51) Int. Cl. G01N 27/414; G01N 27/30

(52) U.S. Cl. CPC G01N 27/4141; G01N 27/301

(57) ABSTRACT

An ion sensor includes an ion detection element, a reference electrode that provides a reference point of a potential, and a solution in which an ion concentration can be changed in a sensing area of the ion detection element. The sensing area of the ion detection element is disposed in the solution. A method for detecting a target substance employs an ion sensor. The target substance bound to a label having a function of changing the amount of ions detectable by the ion sensor is introduced into the solution, and a change in the amount of ions is detected using the ion sensor.

### CROSS REFERENCE TO RELATED APPLICATION

The present application is a continuation application of International Patent Application No. PCT/JP2022/032626 filed on Aug. 30, 2022, which designated the U.S. and claims the benefit of priority from Japanese Patent Application No. 2021-151177 filed on Sep. 16, 2021. The entire disclosures of all of the above applications are incorporated herein by reference.

### REFERENCE TO AN ELECTRONIC SEQUENCE LISTING

This application contains references to amino acid sequences and/or nucleic acid sequences which have been submitted concurrently herewith as the sequence listing .xml file entitled “004664usco_SequenceListing.xml”, file size 2,032 bytes, created on Feb. 20, 2024. The aforementioned sequence listing is hereby incorporated by reference in its entirety pursuant to 37 C.F.R. § 1.52(e)(5).

### TECHNICAL FIELD

The present disclosure relates to an ion sensor and a method for detecting a substance being detected.

### BACKGROUND

An ion sensor includes an ion detection element. As the ion sensor, there is a pH sensor. As the ion detection element, a pH glass electrode and an ISFET (Ion Sensitive Field Effect Transistor) are known.

### SUMMARY

According to an aspect of the present disclosure, an ion sensor includes an ion detection element, a reference electrode that provides a reference point of a potential, and a solution whose ion concentration is changeable in a sensing area of the ion detection element. The sensing area of the ion detection element is disposed in the solution.

### BRIEF DESCRIPTION OF DRAWINGS

FIG. 1 is a side sectional view illustrating a configuration of an ion sensor according to a first embodiment.

FIG. 2 is a side sectional view illustrating a sensor unit and a configuration around the sensor unit according to the first embodiment.

FIG. 3 is a graph illustrating a result of continuously acquiring the output of the ion sensor from the time when the solution is introduced into the container.

FIG. 4 is a graph illustrating a result of continuously detecting the pH of the solution immediately after the solution is replaced.

FIG. 5 is an explanatory diagram illustrating metabolism occurring in the solution.

FIG. 6 is a graph illustrating a change in pH of the solution when 60 minutes passes after each sample is added to the solution.

FIG. 7A is a side sectional view illustrating a groove, FIG. 7B is a side sectional view illustrating a protrusion formed in a double manner, and FIG. 7C is a side sectional view illustrating a groove formed in a double manner.

FIG. 8 is a sectional view taken along a line VIII-VIII in FIG. 1.

FIG. 9 is a perspective view illustrating a configuration of an ion sensor according to a second embodiment.

FIG. 10 is a plan view of the ion sensor of the second embodiment as viewed from a viewpoint PX.

FIG. 11 is a plan view of the ion sensor of the second embodiment as viewed from a viewpoint PY.

FIG. 12 is a side sectional view illustrating a configuration of an ion sensor according to a third embodiment.

FIG. 13A is a plan view illustrating a groove of the sensor unit viewed from the viewpoint PX, FIG. 13B is a plan view illustrating a protrusion of the sensor unit formed in a double manner viewed from the viewpoint PX, and FIG. 13C is a plan view illustrating a groove of the sensor unit formed in a double manner viewed from the viewpoint PX.

### DETAILED DESCRIPTION

An ion sensor includes an ion detection element. As the ion sensor, there is a pH sensor. As the ion detection element, a pH glass electrode and an ISFET (Ion Sensitive Field Effect Transistor) are known.

As a result of the inventors' detailed studies, the following issues have been found. In case of measuring ions of a solution using a conventional ion sensor, the output of the ion sensor drifts and is not stable until a hydrated layer is formed at the sensing interface after the ion detection element and the solution come into contact with each other. Therefore, the user has to wait until the output of the ion sensor is stabilized after the ion detection element and the solution come into contact with each other.

In one aspect of the present disclosure, it is preferable to provide an ion sensor and a method for detecting a target substance so as to shorten the time until the output is stabilized.

One aspect of the present disclosure is an ion sensor. The ion sensor includes an ion detection element, a reference electrode that provides a reference point of a potential, and a solution whose ion concentration is changeable in a sensing area of the ion detection element. The sensing area of the ion detection element is disposed in the solution.

In the ion sensor according to the one aspect of the present disclosure, the sensing area of the ion detection element is disposed in the solution. Therefore, the drift of the output of the ion detection element is made in a settled state. As a result, when the ion sensor according to the one aspect of the present disclosure is used, the time until the output is stabilized can be shortened.

Another aspect of the present disclosure is a method for detecting a target substance using an ion sensor. The ion sensor includes an ion detection element, a reference electrode that provides a reference point of a potential, and a solution in which an ion concentration is changeable in a sensing area of the ion detection element. In the ion sensor, the sensing area of the ion detection element is disposed in the solution. In the method for detecting a target substance, the target substance bound to a label having a function of changing the amount of ions detectable by the ion sensor is introduced into the solution, and a change in the amount of ions according to a concentration of the label is detected using the ion sensor.

In the method for detecting the target substance, an ion sensor is used. In the ion sensor, the sensing area of the ion detection element is disposed in the solution. Therefore, the drift of the output of the ion detection element is made in a settled state. As a result, in the method for detecting the target substance, it is possible to shorten the time until the output of the ion sensor is stabilized.

Exemplary embodiments of the present disclosure will be described with reference to the drawings.

### First Embodiment

### 1. Configuration of Ion Sensor 1

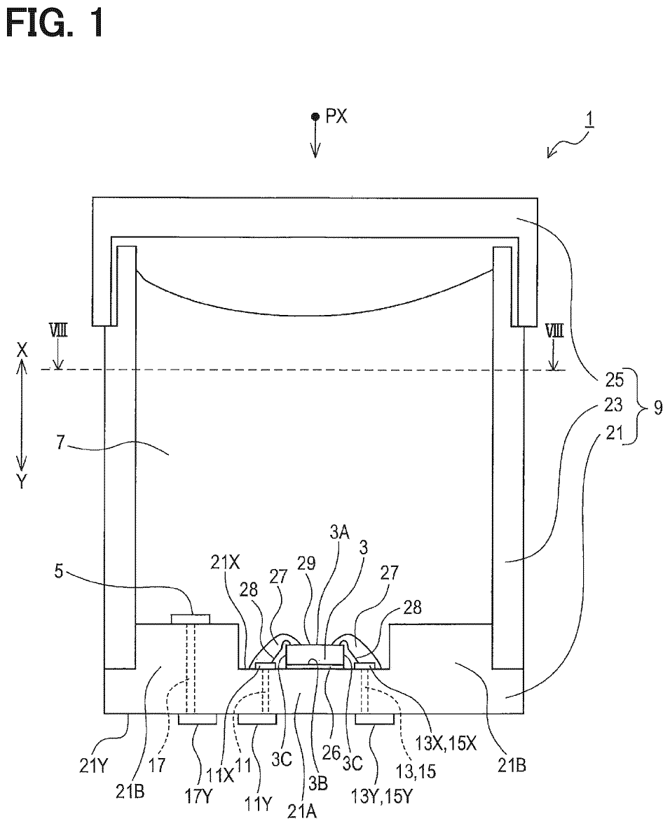

A configuration of the ion sensor 1 will be described with reference to FIGS. 1, 2, and 8. As illustrated in FIG. 1, the ion sensor 1 includes a sensor unit 3, a reference electrode 5 that provides a reference point of a potential, a solution 7, a container 9, ISFET connection terminals 11, 13, and 15, and a reference electrode connection terminal 17.

The container 9 comprises a bottom portion 21, a side portion 23 and a lid 25. The lid 25 is removable. When the lid 25 is attached, the inside of the container 9 is sealed. The bottom portion 21 is formed of, for example, a molded body, a printed circuit board, or the like.

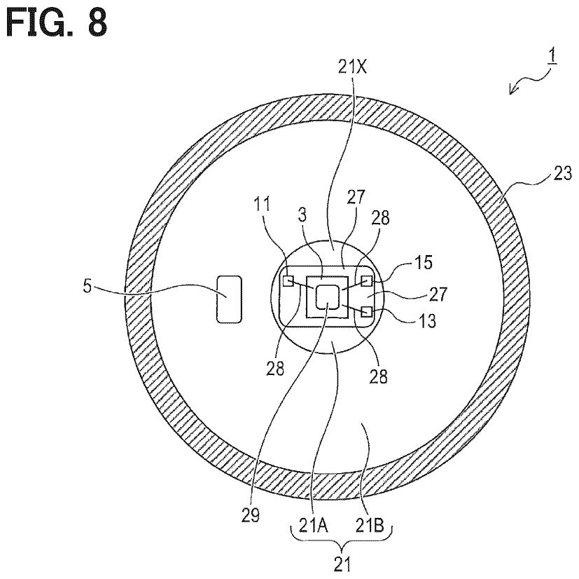

As shown in FIGS. 1 and 8, the side portion 23 has a cylindrical shape. The bottom portion 21 is attached to one of the two ends of the side portion 23. The lid 25 is attached to the other of the two ends of the side portion 23 on the opposite side. The openings at the two ends of the side portion 23 are closed by the bottom portion 21 and the lid 25 respectively.

The connection between the side portion 23 and the bottom portion 21 is sealed by, for example, a screw structure, an adhesive such as epoxy, welding using laser or heat, press fitting, sealing via a gasket such as an O-ring, insert molding, or the like. The connection between the side portion 23 and the lid 25 is sealed by, for example, an elastic material such as rubber, a screw structure, an aluminum pouch, a film, or the like.

As indicated by an arrow in FIG. 1, an X direction is defined to extend from the bottom portion 21 toward the lid 25. A direction opposite to the X direction is defined as a Y direction. The ion sensor 1 is usually used in a state where the Y direction coincides with the vertical direction. A surface of the bottom portion 21 in the X direction is referred to as an X-side surface 21X. A surface of the bottom portion 21 in the Y direction is referred to as a Y-side surface 21Y.

The bottom portion 21 includes a concave portion 21A and a convex portion 21B. In the convex portion 21B, the X-side surface 21X protrudes in the X direction more than the concave portion 21A. As shown in FIG. 8, when viewed from the viewpoint PX, the concave portion 21A is located at the center, and the convex portion 21B is located on the peripheral side. The concave portion 21A has a circular shape, and the convex portion 21B has an annular shape.

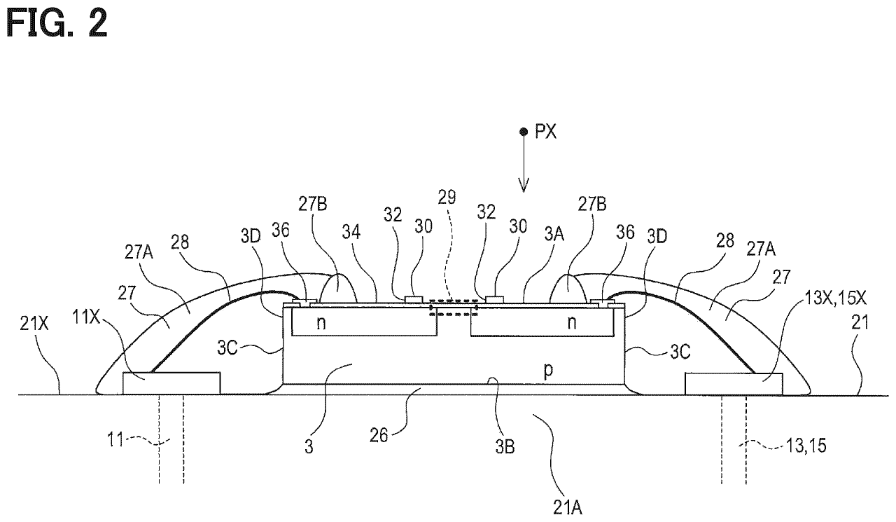

The sensor unit 3 includes an ISFET. The ISFET corresponds to an ion detection element. As shown in FIG. 1, the sensor unit 3 is disposed inside the container 9. As shown in FIG. 2, the sensor unit 3 is fixed on the X-side surface 21X by the fixing member 26 in the concave portion 21A. The sensor unit 3 has an X-side surface 3A, a Y-side surface 3B, and an end surface 3C. The X-side surface 3A is a main surface in the X direction. The X-side surface 3A is in contact with the solution 7. The Y-side surface 3B is a main surface in the Y direction. The fixing member 26 is in contact with the Y-side surface 3B. The end surface 3C defines an outer peripheral end of the sensor unit 3 when viewed from the viewpoint PX.

As shown in FIGS. 1, 2 and 8, the protective member 27 is attached to the concave portion 21A. As shown in FIG. 8, when viewed from the viewpoint PX, the protective member 27 is disposed so as to surround the sensor unit 3. The protective member 27 is in contact with a contact portion 3D which is a part of the surface of the sensor unit 3. The contact portion 3D includes the end surface 3C. The contact portion 3D further includes a part of the X-side surface 3A adjacent to the end surface 3C. The contact portion 3D includes an edge of a boundary between the end surface 3C and the X-side surface 3A. However, the contact portion 3D does not include a sensing area 29 described later. The protective member 27 is in contact with the X-side surface 21X around the sensor unit 3. The protective member 27 includes a filling agent 27A and a dam agent 27B. The dam agent 27B is located on the X-side surface 3A. The dam agent 27B is located closer to the sensing area 29 than the filling agent 27A. The dam agent 27B restricts the filling agent 27A from advancing toward the sensing area 29.

Plural bonding wires 28 are provided inside the protective member 27. The bonding wire 28 is covered with the protective member 27. The protective member 27 is made of an insulating material such as an epoxy resin. The protective member 27 has a function of protecting and insulating the bonding wire 28 and a function of protecting the end surface 3C. The bonding wire 28 electrically connects the ISFET of the sensor unit 3 to the ISFET connection terminal 11, 13, 15.

The sensing area 29 is provided on the X-side surface 3A. The sensing area 29 detects ions to be detected by the ISFET (hereinafter referred to as target ions). In the present embodiment, the target ion is a hydrogen ion. The sensing area 29 is located near the center of the X-side surface 3A when viewed from the viewpoint PX. The sensing area 29 is not covered with the protective member 27.

As shown in FIG. 2, the sensor unit 3 includes a gate insulating film 34 and an aluminum pad 36 on the side in the X direction. The X-side surface 3A is a surface of the gate insulating film 34. The aluminum pad 36 is provided to conduct electricity to the bonding wire 28.

As shown in FIG. 2, a protrusion 30 is formed on the X-side surface 3A. When viewed from the viewpoint PX, the shape of the protrusion 30 is annular. The protrusion 30 is arranged to surround the sensing area 29.

When viewed from the viewpoint PX, the protective member 27 is located outside the protrusion 30. A part of the protrusion 30 is provided between the sensing area 29 and the protective member 27. The protrusion 30 protrudes in the X direction as compared with the X-side surface 3A around the protrusion 30. Therefore, a step 32 is formed between the protrusion 30 and the X-side surface 3A around the protrusion 30.

The reference electrode 5 is disposed inside the container 9. The reference electrode 5 is attached to the X-side surface 21X of the convex portion 21B. The reference electrode 5 is located on the X-direction side of the sensor unit 3. That is, the reference electrode 5 is located closer to the lid 25 than the sensor unit 3. The reference electrode 5 is an Ag/AgCl electrode.

As shown in FIG. 1, the solution 7 is contained in the container 9. The solution 7 is a solution whose ion concentration can be changed in the sensing area 29. The solution 7 is an aqueous solution containing chloride ions. The concentration of chloride ions is within a range between 0.01M and 3M. When the concentration of chloride ions is within the range between 0.01M and 3M, the output fluctuation of the ion sensor 1 can be further suppressed. The output of the ion sensor 1 is, for example, a current value associated with a potential change of the sensing area 29. The chloride ion is necessary for the redox reaction of the reference electrode 5. The solution 7 is contained in the container 9, for example, even when the ion sensor 1 is not used.

As shown in FIG. 1, the sensor unit 3 is disposed in the solution 7. Therefore, the sensing area 29 is also disposed in the solution 7. The reference electrode 5 is also arranged in the solution 7. During normal use of the ion sensor 1, the reference electrode 5 is positioned on the liquid surface side of the solution 7 with respect to the sensor unit 3.

The ISFET connection terminal 11, 13, 15 and the reference electrode connection terminal 17 are made of a conductive material such as metal. The ISFET connection terminal 11, 13, 15 and the reference electrode connection terminal 17 are embedded in the bottom portion 21 by resin molding.

The ISFET connection terminal 11 includes an electrode portion 11X exposed on the X-side surface 21X. The bonding wire 28 is connected to the ISFET connection terminal 11 at the electrode portion 11X. The electrode portion 11X is covered with the protective member 27. Further, the ISFET connection terminal 11 includes an electrode portion 11Y exposed on the Y-side surface 21Y.

The ISFET connection terminal 13 includes an electrode portion 13X exposed on the X-side surface 21X. The bonding wire 28 is connected to the ISFET connection terminal 13 at the electrode portion 13X. The electrode portion 13X is covered with the protective member 27. Further, the ISFET connection terminal 13 includes an electrode portion 13Y exposed on the Y-side surface 21Y.

The ISFET connection terminal 15 includes an electrode portion 15X exposed on the X-side surface 21X. The bonding wire 28 is connected to the ISFET connection terminal 15 at the electrode portion 15X. The electrode portion 15X is covered with the protective member 27. Further, the ISFET connection terminal 15 includes an electrode portion 15Y exposed on the Y-side surface 21Y.

The reference electrode connection terminal 17 is electrically connected to the reference electrode 5. The reference electrode connection terminal 17 includes an electrode portion 17Y exposed on the Y-side surface 21Y. The electrode portion 11Y, 13Y, 15Y, 17Y can output a signal of the ion sensor 1 to an external device.

A part of the inside of the container 9 is occupied by gas. The gas is, for example, an inert gas. The inert gas is, for example, nitrogen or the like.

The ion sensor 1 can be used, for example, as follows. The lid 25 is removed and a target substance to be detected is added to the solution 7. Thereafter, the internal space of the container 9 is sealed by the lid 25, and the gas inside the container 9 is replaced with an inert gas. The target substance may be a solid, a liquid, or a gas. The addition of the target substance changes the amount of target ions in the solution 7.

For example, the amount of the target ion in the solution 7 is changed by causing a reaction in which a label bonded to the target substance generates or consumes the target ion. The substance involved in the reaction that generates or consumes the target ion may be contained in the solution 7 before the ion sensor 1 is used, or may be added to the solution 7 when the ion sensor 1 is used. When the amount of target ions changes, the surface potential of the sensing area 29 changes with reference to the potential provided by the reference electrode 5. This change in surface potential changes the amount of free electrons attracted to the semiconductor surface inside the ISFET. The change in the amount of ions is detected by measuring a current value associated with a change in the amount of free electrons. The ion sensor 1 detects the change in the amount of ions according to the concentration of the label.

### 2. Method for Detecting Target Substance

In the method for detecting the target substance, the ion sensor 1 is used. The ion sensor 1 is as described in the above section “1. Configuration of ion sensor 1.”

In the method for detecting the target substance, the target substance is introduced into the solution 7. The target substance is bound to the label at the introduction time. The label has a function of changing the amount of ions present in the solution 7. The ion sensor 1 can detect the ions.

The ion sensor 1 is used to detect a change in the amount of ions in the solution 7. As the amount of the target substance introduced into the solution 7 increases, the number of labels increases and the change in the amount of ions also increases. That is, the change in the amount of ions corresponds to the concentration of the label. The change in the amount of ions is, for example, proportional to the concentration of the label. Therefore, in the method for detecting the target substance, the target substance can be detected based on the change in the amount of ions in the solution 7. The presence or absence of the target substance can be qualitatively determined by the method for detecting the target substance. In addition, the amount of the target substance can be quantified by the method for detecting the target substance.

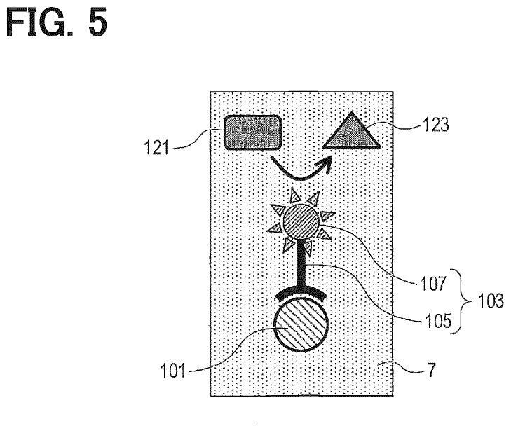

For example, as shown in FIG. 5, a conjugate 103 is bound to the target substance such as a virus 101. The conjugate 103 includes a binding substance 105 and a label 107. The binding substance 105 has an activity of binding to the target substance. The label 107 is bound to the target substance via the binding substance 105. Examples of the binding substance 105 include a low-molecular protein preparation, a nucleic acid aptamer, a monoclonal antibody, and a polyclonal antibody.

Examples of the low-molecular protein preparation include fragment antibody, single chain antibody, Diabody, Nanobody, VHH, peptide aptamer and the like.

The number of bases of the nucleic acid aptamer falls within a range, for example, between 10, inclusive, and 100, inclusive. When the number of bases is 100 or less, even when the target substance is close to the other substance, the conjugate 103 is less likely to be interfered by the other substance and easily bound to the target substance.

The nucleic acid aptamer may be, for example, one in which plural units each consisting of a nucleic acid are linked to each other. The number of bases in each of the units preferably falls within a range between 10, inclusive, and 100, inclusive. When the number of bases is 100 or less, even when the target substance is close to the other substance, the conjugate 103 is less likely to be interfered by the other substance and easily bound to the target substance.

Examples of the nucleic acid aptamer include a DNA aptamer and an RNA aptamer. The binding substance 105 can be chemically synthesized, for example, by an in vitro process. The binding substance 105 is bound to the target substance, for example, by an intramolecular interaction such an antibody-antigen interaction. The intermolecular interaction like the antigen-antibody interaction include hydrogen bonds, bonds by electrostatic complementarity bonds, bonds by hydrophobic contact, steric bonds and the like.

The label 107 is fused to the binding substance 105. The label 107 has a function of changing the amount of ions detectable by the ion sensor 1. Examples of the label 107 include an enzyme. The enzyme has, for example, an activity of inducing a metabolism starting from a substrate (hereinafter, referred to as an enzymatic activity). Examples of the metabolism include metabolism for producing hydrogen ions and metabolism for consuming hydrogen ions.

When metabolism that produces hydrogen ions or metabolism that consumes hydrogen ions occurs, the concentration of hydrogen ions in the solution 7 changes. As the enzyme, one or more is/are selected, for example, from a group consisting of protoporphyrinogen oxidase, D-arabinose 1-dehydrogenase, 15-hydroxyprostaglandin dehydrogenase, cyclohexane-1,2-diol dehydrogenase, 1,3-propanediol dehydrogenase, uronate dehydrogenase, 2′-dehydrocanamycin reductase, cholesterol oxidase, Lactaldehyde dehydrogenase, 2,5-dioxovalerate dehydrogenase, cinnamoyl-CoA reductase, betaine-aldehyde dehydrogenase, Arsenate reductase, 2-enoate reductase, fumarate reductase, coproporphyrinogen dehydrogenase, 3-oxosteroid 1-dehydrogenase, 3-oxo-5alpha-steroid 4-dehydrogenase, alanine dehydrogenase, diaminopimelate dehydrogenase, Alkaline phosphatase, beta-lactamase, carbonyl reductase, shikimate dehydrogenase, D-lactate dehydrogenase, malate dehydrogenase, diacetyl reductase, D-xylose reductase, glucose-6-phosphate dehydrogenase, isocitrate dehydrogenase, 3alpha-hydroxysteroid 3-dehydrogenase, glycerol-3-phosphate dehydrogenase, chloride peroxidase, formate dehydrogenase, ferredoxin-NADP+ reductase, rubredoxin-NAD(P)+ reductase, aspartate-semialdehyde dehydrogenase, aspartate dehydrogenase, aldehyde dehydrogenase, glutamate dehydrogenase, NADPH-hemoprotein reductase, NAD(P)H dehydrogenase, dihydrolipoyl dehydrogenase, thioredoxin-disulfide reductase, sulfite dehydrogenase, Carbonic Anhydrase, Glucokinase, and peroxidase.

For example, each of the label 107 and the binding substance 105 has a chemical substituent. For example, the label 107 is fused to the binding substance 105 by bonding the chemical substituent of the label 107 and the chemical substituent of the binding substance 105.

Examples of the chemical substituent of the label 107 include avidin, streptavidin, neutravidin, N-hydroxy succinimide, azide, alkyne, dibenzo cycloactin, bicyclononin, 2′-O-propargyl, 2′-O-propargyl, thiol, and maleimide.

Examples of the chemical substituent of the binding substance 105 include biotin, primary amine, azide, alkyne, dibenzo cycloactin, bicyclononin, 2′-O-propargyl, 2′-O-propargyl, and thiol.

Examples of the target substance include proteins, sugars, lipids, antigens, cells, and viruses. Examples of the antigen include an antigen presented by a cell or a virus, an antigen contained in a cell or a virus, and the like. Examples of the antigen presented by the cell or virus, or the antigen contained in the cell or virus, include RBD region (hereinafter referred to as RBD) in the novel coronavirus SARS-CoV-2. Examples of the virus include the novel coronavirus SARS-CoV-2 and the like.

### 3. Effects of Ion Sensor 1 and Method for Detecting Target Substance

(1A) The sensing area 29 is disposed in the solution 7. Therefore, the ISFET is in a state where the drift of the output is settled. As a result, by using the ion sensor 1, it is possible to shorten the time until the output is stabilized. The reason why the drift of the output of the ISFET is stabilized is presumed to be that a hydrated layer is formed between the surface of the sensing area 29 and the solution 7 when the sensing area 29 is disposed in the solution 7, or that sodium ions are infiltrated into the sensing area 29.

The reference electrode 5 is disposed in the solution 7. Therefore, the reference electrode 5 is in a state where the drift of the output is settled. As a result, by using the ion sensor 1, it is possible to shorten the time until the output is stabilized.

In order to confirm the above effects, the following tests were performed. First, the ion sensor 1 in which the solution 7 is not contained in the container 9 is prepared. Next, the solution 7 is introduced into the container 9. From the time when the solution 7 is introduced, the output of the ion sensor 1 is continuously acquired.

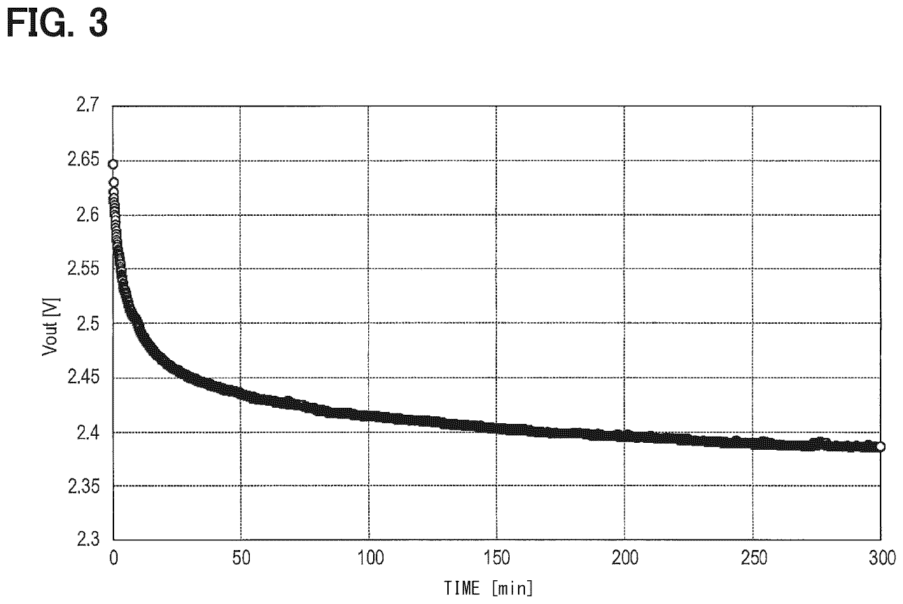

The output of the ion sensor 1 is shown in FIG. 3. The drift of the output was large immediately after the solution 7 was introduced into the container 9. The drift of the output became small as time passed. During normal use, the ion sensor 1 is in an immersed state in which the sensing area 29 and the reference electrode 5 are immersed in the solution 7. The drift of the output of the ion sensor 1 in the immersed state is expected to be small and stable, such as the drift of the output at 300 minutes shown in FIG. 3.

(1B) When the ion sensor 1 is stored, the sensing area 29 and the reference electrode 5 are disposed in the solution 7. Therefore, contaminants adhering to the sensing area 29 are limited as compared with a case where the sensing area 29 is exposed to the atmosphere. As a result, it is possible to predict the characteristic variation of the ion sensor 1 due to the attachment of the contaminant.

(1C) A conventional reference electrode includes an Ag/AgCl electrode, a glass container housing the Ag/AgCl electrode, and a KCl solution filling the glass container. The glass container has a liquid entanglement. The liquid entanglement electrically connects the solution to be detected and the KCL solution in the glass container. When a conventional reference electrode is used, the KCl solution may pass through the liquid entanglement and seep into the solution 7. In this case, the salt concentration of the solution 7 changes, and the detection accuracy of the ion sensor 1 decreases.

In the ion sensor 1, the solution 7 contains chloride ions. Therefore, the reference electrode 5 may not include the glass container and the KCl solution filling the inside of the glass container. As a result, the exudation of the KCl solution can be suppressed.

(1D) The container 9 is sealed. Therefore, even when the ion sensor 1 is stored for a long period of time, it is possible to suppress CO₂ or the like in the atmosphere from dissolving into the solution 7. As a result, the fluctuation of the pH in the solution 7 can be suppressed.

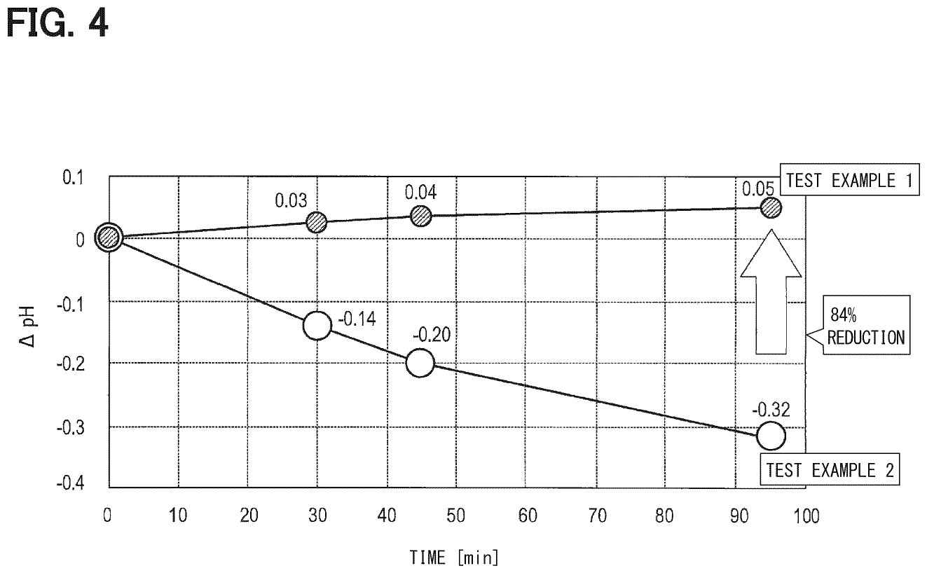

In order to confirm the above effects, the following tests were performed. In Test Example 1, the solution 7 of the ion sensor 1 was replaced. Immediately after the solution 7 was replaced, the lid 25 was closed and the space in the container 9 was purged with nitrogen gas. In Test Example 2, the solution 7 of the ion sensor 1 was replaced. In Test Example 2, after the solution 7 was replaced, the lid 25 was left unattached. In each of Test Examples 1 and 2, immediately after the solution 7 was replaced, the pH of the solution 7 was continuously detected using the ion sensor 1. The detection results were shown in FIG. 4.

In Test Example 1, the change in pH was small. The reason is that by closing the lid 25 and purging the space in the container 9 with nitrogen gas, it was possible to suppress CO₂ and the like in the atmosphere from dissolving into the solution 7. In Test Example 2, the change in pH was large. The reason is that since the lid 25 was opened, a large amount of CO₂ or the like in the atmosphere was dissolved in the solution 7.

(1E) The resin contained in the protective member 27 may cause bleeding. The ion sensor 1 includes the protrusion 30. The protrusion 30 changes the direction of travel of the bleeding. In addition, since the protrusion 30 is present, the path from the resin to the sensing area 29 becomes long. Therefore, even when the protective member 27 causes bleeding, the protrusion 30 suppresses the bleeding from reaching the sensing area 29. As a result, it is possible to suppress a decrease in detection accuracy of the ion sensor 1 due to bleeding.

(1F) In the method for detecting the target substance, the ion sensor 1 is used. Therefore, the effects of (1A) to (1E) can be achieved.

### 4. Examples

### (4-1) Synthesis of Conjugate 103

A DNA aptamer having the base sequence of SEQ ID NO. 1 (hereinafter, referred to as an unmodified DNA aptamer) is chemically synthesized by an in vitro process. The base sequence of the unmodified DNA aptamer is “5′-CAGCACCGAC CTTGTGCTTT GGGAGTGCTG GTCCAAGGGC GTTAATGGAC A-3′.” The unmodified DNA aptamer is described in Anal. Chem. 2020, 92, 9895-9900 (hereinafter, referred to as Reference 1).

According to the description in Reference 1, the unmodified DNA aptamer is a DNA aptamer whose target substance is the RBD of the spike glycoprotein of the novel coronavirus SARS-CoV-2. Next, 5′end of the unmodified DNA aptamer is chemically modified with biotin via a C6 spacer.

Through the above steps, a DNA aptamer was obtained. The DNA aptamer corresponds to the binding substance 105. The DNA aptamer is dissolved in a phosphate buffer solution (hereinafter, referred to as 1×PBS/T) to prepare a DNA aptamer solution. The concentration of the DNA aptamer in the DNA aptamer solution is 10 μmol/l.

The 1×PBS/T contains 0.05% (v/v) of the surfactant Tween 20. The 1×PBS/T contains 137 mmol/l of NaCl, 8.1 mmol/l of Na₂HPO₄, 2.7 mmol/l of KCl and 1.47 mmol/l of KH₂PO₄.

As the label 107, a streptavidin-alkaline phosphatase conjugate (Thermofisher Scientific, product number S921) was prepared. The label 107 is an enzyme. The streptavidin-alkaline phosphatase conjugate is obtained by modifying alkaline phosphatase with streptavidin. Streptavidin is a chemical substituent that modifies the label 107. The label 107 was dissolved in 1×PBS/T to prepare a label solution. The concentration of the label 107 in the label solution is 20 μmol/l.

The DNA aptamer solution of 100 μL and the label solution of 5 μL are mixed and let stand at room temperature for 1 hour. At this time, the DNA aptamer and the label 107 were fused by the interaction between biotin-streptavidin, and the conjugate 103 was synthesized.

The conjugate 103 was then purified and recovered. Specifically, a DNA aptamer that did not fused with the label 107 was separated from the conjugate 103 using an ultrafiltration filter, and the conjugate 103 was recovered.

The binding substance 105 may be a binding substance other than the above-mentioned DNA aptamer. The binding substance 105 may be, for example, a low-molecular protein preparation, an RNA aptamer, a monoclonal antibody, or a polyclonal antibody. Examples of the low-molecular protein preparation include fragment antibody, single chain antibody, Diabody, Nanobody, VHH, peptide aptamer and the like.

The base sequence of the DNA aptamer may be a base sequence other than the base sequence of SEQ ID NO. 1. The base sequence of the DNA aptamer can be selected according to the target substance. The fusion of the binding substance 105 and the label 107 may be a fusion other than the fusion based on the biotin-streptavidin interaction. When the nucleic acid aptamer is used as the binding substance 105, the end of the nucleic acid aptamer other than the 5′end may be fused with the label 107.

When the low-molecular protein preparation is used as the binding substance 105, the N-terminal or C-terminal of the low-molecular protein preparation may be fused with the label 107. When a monoclonal antibody or a polyclonal antibody is used as the binding substance 105, the N-terminal end or the C-terminal end of the monoclonal antibody or the polyclonal antibody may be fused with the label 107 while the binding property with the target substance is not lost by the fusion with the label 107.

### (4-2) Implementation of Method for Detecting Target Substance

As the target substance, the novel coronavirus SARS-CoV-2 (hereinafter, referred to as SARS-CoV-2) was prepared. By suspending SARS-CoV-2 in 1×PBS/T, eight types of suspensions were prepared. The eight suspensions differ only in the copy numbers of SARS-CoV-2 contained in the suspensions. The copy number of SARS-CoV-2 in each of the eight suspensions was 0, 10 to the power of 1, 40, 10 to the power of 2, 10 to the power of 3, 10 to the power of 4, 10 to the power of 5, and 10 to the power of 6, per 1 μL of the suspension in quantitative PCR conversion. The following steps were performed for each of the eight suspensions.

Next, 25 μL of the conjugate solution was added dropwise onto the 25 μL of the suspension, and let it stand at room temperature for 10 minutes. The conjugate solution is a solution containing the conjugate 103 synthesized in the above-mentioned “(4-1) Synthesis of conjugate 103”. The concentration of the conjugate 103 in the conjugate solution was 10 nmol/l. At this time, some of the conjugates 103 are bound to the target substance.

Next, the entire amount of the suspension after being let stand was added dropwise onto the nanosep centrifugal filtration device with molecular weight cut-off of 300K (manufactured by PALL corporation, product number OD300C34), and high-speed centrifugation was performed. The conjugates 103 that were bound to the target substance were recovered and unbound conjugate 103 that were not bound to the target substance were separated by high-speed centrifugation.

Next, the nanosep centrifugal filtration device with molecular weight cut-off of 300K was washed with 1×PBS/T for 3 times. At this time, the unbound conjugates 103 that were not bound to SARS-CoV-2 were removed. Next, pNPP was dissolved in the solution 7 of the ion sensor 1. The concentration of pNPP in the solution 7 was 10 mmol/l.

Next, the solution 7 was added into the nanosep centrifugal filtration device with molecular weight cut-off of 300 K. At this time, as shown in FIG. 5, in the solution 7, metabolism using pNPP as a substrate 121 was induced by the enzyme activity of alkaline phosphatase, and the phosphate group was separated from pNPP. This resulted in a product 123. The product 123 was inorganic phosphoric acid and p-nitrophenol.

The label 107 containing alkaline phosphatase is fused with the binding substance 105 to form the conjugate 103. The conjugate 103 is associated with the virus 101. The virus 101 is SARS-CoV-2.

The absorption maximum wavelength of p-nitrophenol is 405 nm. Therefore, yellow color developed in the solution 7 containing p-nitrophenol. The produced inorganic phosphoric acid was ionized in the solution 7 to release hydrogen ions. Therefore, the pH of the solution 7 decreased.

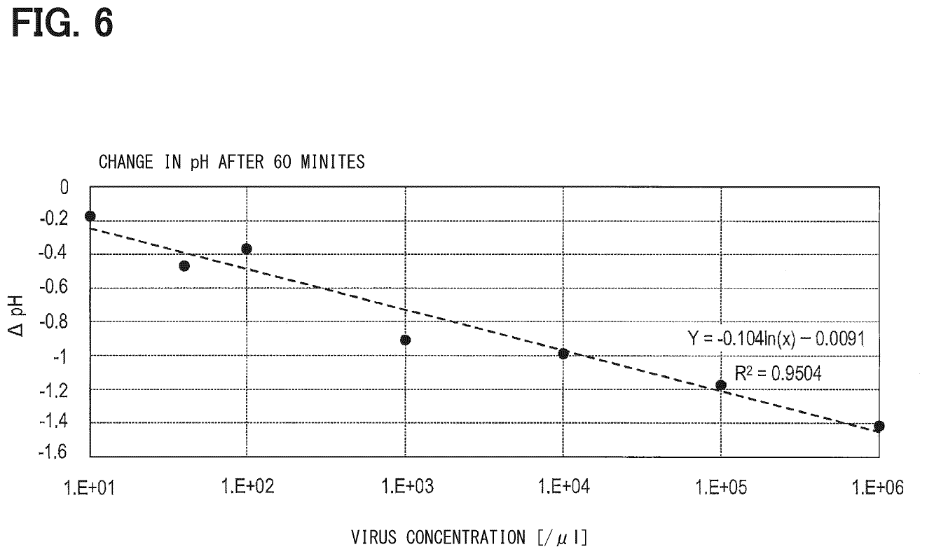

The pH of the solution 7 was continuously recorded. FIG. 6 shows the change in pH after 60 minutes from the time (hereinafter referred to as the initial time) when the solution 7 was added to the nanosep centrifugal filtration device with molecular weight cut-off of 300K. The change in pH is the amount of change from pH at the initial time.

As shown in FIG. 6, the greater the copy numbers of SARS-CoV-2 in the suspension, the greater the amount of change in pH. The amount of change in pH means the change amount of pH from the pH of the blank. The pH recording results indicate the following. The DNA aptamer of the conjugate 103 had a binding activity to SARS-CoV-2 even in the fused state with the label 107. In addition, the alkaline phosphatase of the conjugate 103 had an enzymatic activity that induces metabolism using pNPP as a substrate even in a fused state with the DNA aptamer. In addition, inorganic phosphoric acid was generated by the metabolism using pNPP as a substrate and ionized in the solution to release hydrogen ions. As a result, the pH of the solution 7 decreased. Further, when the copy numbers of SARS-CoV-2 in the suspension was 10³ or more, the amount of change in pH was even greater.

In order to remove the unbound conjugates 103 that were not bound to the target substance, a centrifugal filtration device other than the nanosep centrifugal filtration device with molecular weight cut-off of 300K may be used. The centrifugal filtration device has, for example, a molecular weight cut-off value equivalent to that of the nanosep centrifugal filtration device with molecular weight cut-off of 300K.

The method for removing the unbound conjugates 103 that were not bound to the target substance may be a method other than centrifugal filtration. A method for removing the unbound conjugates 103 that were not bound to the target substance may be a sandwich removing method using an ELISA plate or magnetic beads, a removing method by filtration chromatography using a filter paper or a gel, or a removing method by affinity chromatography carrying an antibody at a carrier such as a gel.

### Second Embodiment

1. Difference from First Embodiment

Since the basic configuration of a second embodiment is the same as that of the first embodiment, differences will be described below. Note that the same reference numerals as those in the first embodiment indicate the same configuration, and refer to the preceding descriptions.

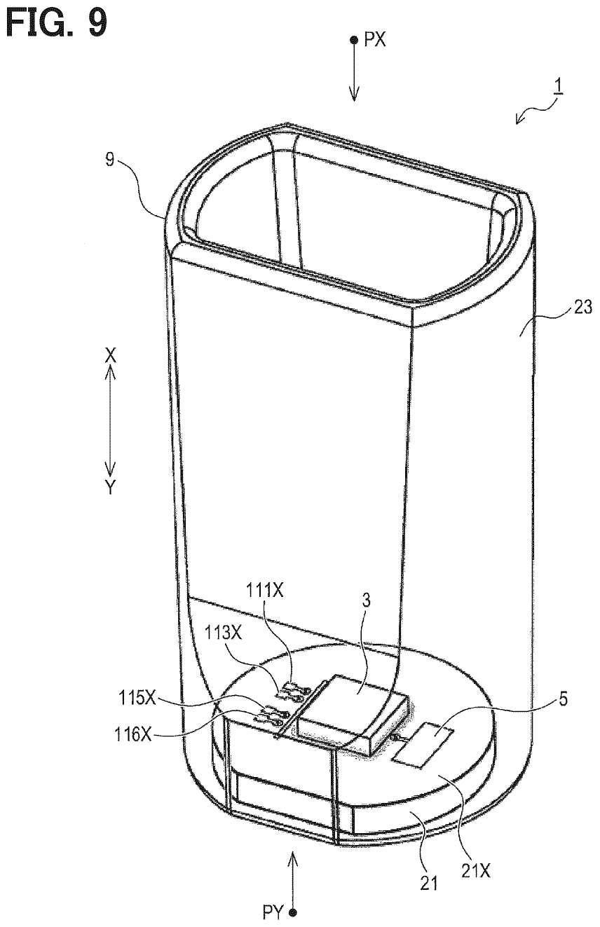

The ion sensor 1 of the second embodiment has the configuration shown in FIGS. 9 to 11. In FIG. 9, the solution 7, the lid 25, and the protective member 27 are not illustrated.

The bottom portion 21 is a printed circuit board. The bottom portion 21 does not include the concave portion 21A and the convex portion 21B, and the X-side surface 21X is flat. In the cross-section orthogonal to the X direction, the bottom portion 21 has an oval shape.

The sensor unit 3 is fixed to the center of the X-side surface 21X by an adhesive. The sensor unit 3 includes an ISFET and a temperature sensor. The bottom portion 21 corresponds to a base material to which the sensor unit 3 is attached.

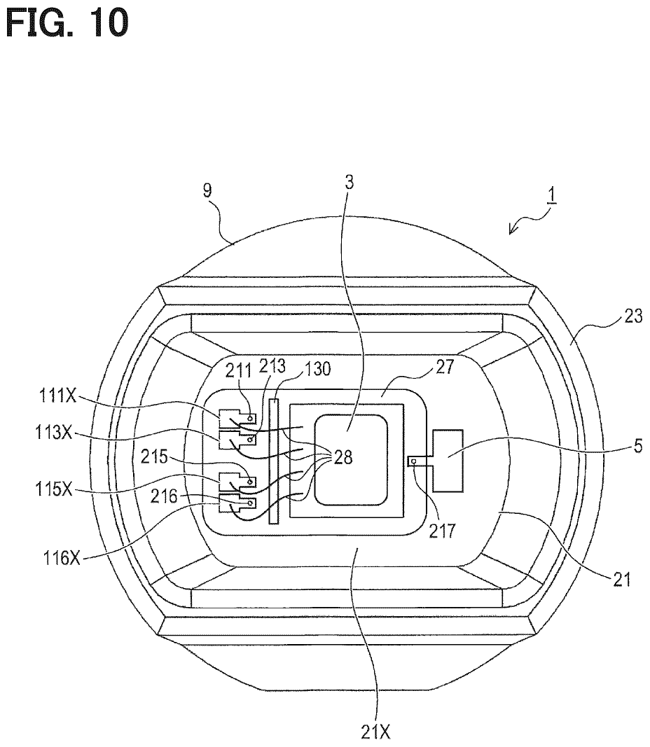

FIG. 10 is a plan view of the ion sensor 1 viewed from the viewpoint PX. As shown in FIG. 10, electrode portions 111X, 113X, 115X, and 116X are formed on the X-side surface 21X. Each of the electrode portions 111X, 113X, 115X, and 116X is a metal thin film. Each of the electrode portions 111X, 113X, 115X, and 116X has a rectangular shape. Each of the electrode portions 111X, 113X, and 115X is electrically connected to an ISFET included in the sensor unit 3 by a bonding wire 28. The electrode portion 116X is electrically connected to a temperature sensor included in the sensor unit 3 by a bonding wire 28.

As shown in FIG. 10, the reference electrode 5 is formed on the X-side surface 21X. The reference electrode 5 is a film of AgCl. The silver chloride film corresponds to a metal film. The reference electrode 5 has a rectangular shape. As shown in FIGS. 9 and 10, when viewed from the viewpoint PX, the electrode portions 111X, 113X, 115X, and 116X are arranged on one side with respect to the sensor unit 3. The reference electrode 5 is provided on a side opposite to the electrode portion 111X, 113X, 115X, 116X with respect to the sensor unit 3. The sensor unit 3 is positioned between the electrode portion 111X, 113X, 115X, 116X and the reference electrode 5. The size of the plane of the reference electrode 5 as viewed from the viewpoint PX is larger than that of the electrode portion 111X, 113X, 115X, 116X.

A protrusion 130 is formed on the X-side surface 21X between the sensor unit 3 and the electrode portion 111X, 113X, 115X, 116X. When viewed from the viewpoint PX, the shape of the protrusion 130 is a straight line. The protrusion 130 crosses an imaginary straight line connecting each of the electrode portions 111X, 113X, 115X, and 116X and the sensor unit 3. The protrusion 130 protrudes in the X direction from the X-side surface 21X around the protrusion 130. Therefore, a step is formed between the protrusion 130 and the X-side surface 21X around the protrusion 130.

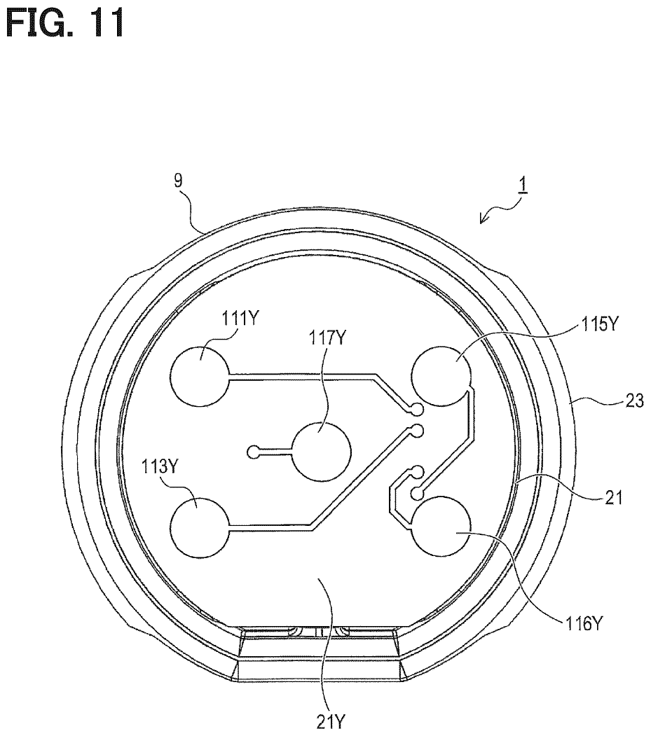

FIG. 11 is a plan view of the ion sensor 1 viewed from the viewpoint PY. As shown in FIG. 11, electrode portions 111Y, 113Y, 115Y, 116Y, and 117Y are formed on the Y-side surface 21Y. Each of the electrode portions 111Y, 113Y, 115Y, 116Y, and 117Y is a metal thin film.

The bottom portion 21 has through holes 211, 213, 215, 216, and 217. The through hole 211 is located at a position overlapping a part of the electrode portion 111X when viewed from the viewpoint PX. The electrode portion 111X is electrically connected to the electrode portion 111Y through the through hole 211.

The through hole 213 is located at a position overlapping a part of the electrode portion 113X when viewed from the viewpoint PX. The electrode portion 113X is electrically connected to the electrode portion 113Y through the through hole 213.

The through hole 215 is located at a position overlapping a part of the electrode portion 115X when viewed from the viewpoint PX. The electrode portion 115X is electrically connected to the electrode portion 115Y through the through hole 215.

The through hole 216 is located at a position overlapping a part of the electrode portion 116X when viewed from the viewpoint PX. The electrode portion 116X is electrically connected to the electrode portion 116Y through the through hole 216.

The through hole 217 is located at a position overlapping a part of the reference electrode 5 when viewed from the viewpoint PX. The reference electrode 5 is electrically connected to the electrode portion 117Y through the through hole 217. The electrode portions 111Y, 113Y, 115Y, 116Y, and 117Y can output a signal of the ion sensor 1 to an external device.

As shown in FIG. 10, the protective member 27 is disposed so as to surround the sensor unit 3 on the X-side surface 21X. The protective member 27 covers the protrusion 130, the bonding wire 28, the electrode portions 111X, 113X, 115X, and 116X, and the through holes 211, 213, 215, 216, and 217. The protective member 27 covers a part of the reference electrode 5 including the connection with the through hole 217, and does not cover the other part of the reference electrode 5. The protective member 27 fills the hollow of the through holes 211, 213, 215, 216, and 217.

### 2. Effects of Ion Sensor 1 and Method for Detecting Target Substance

The second embodiment described in detail provides the effects (1A) through (1F) described in the first embodiment and the following effects in addition.

(2A) The adhesive for fixing the sensor unit 3 may cause bleeding. The ion sensor 1 includes the protrusion 130 between the sensor unit 3 and the electrode portion 111X, 113X, 115X, 116X. The protrusion 130 changes the travel direction of the bleeding. In addition, the presence of the protrusion 130 lengthens the path from the adhesive to the electrode portion 111X, 113X, 115X, 116X. Therefore, even when the adhesive causes bleeding, the protrusion 130 suppresses the bleeding from reaching the electrode portion 111X, 113X, 115X, 116X. As a result, deterioration of the electrode portions 111X, 113X, 115X, 116X due to bleeding is suppressed. In addition, it is possible to suppress the occurrence of a defect in the bonding between the electrode portion 111X, 113X, 115X, 116X and the bonding wire 28.

The reference electrode 5 is larger than the electrode portion 111X, 113X, 115X, 116X. Therefore, even when the bleeding reaches the reference electrode 5, the influence of the bleeding on the reference electrode 5 is small. Therefore, the protrusion 130 may not be provided between the sensor unit 3 and the reference electrode 5. When the protrusion 130 is not provided between the sensor unit 3 and the reference electrode 5, the structure of the ion sensor 1 can be simplified.

(2B) The protective member 27 fills the hollow of the through holes 211, 213, 215, 216, and 217. Therefore, it is possible to suppress the solution 7 from leaking through the through holes 211, 213, 215, 216, and 217.

(2C) The sensor unit 3 includes a temperature sensor. Therefore, the ion sensor 1 can detect the temperature of the solution 7.

### Third Embodiment

1. Difference from First Embodiment

A basic configuration of the third embodiment is the same as that of the first embodiment, and differences from the first embodiment will be described below. Note that the same reference numerals as those in the first embodiment indicate the same configuration, and refer to the preceding descriptions.

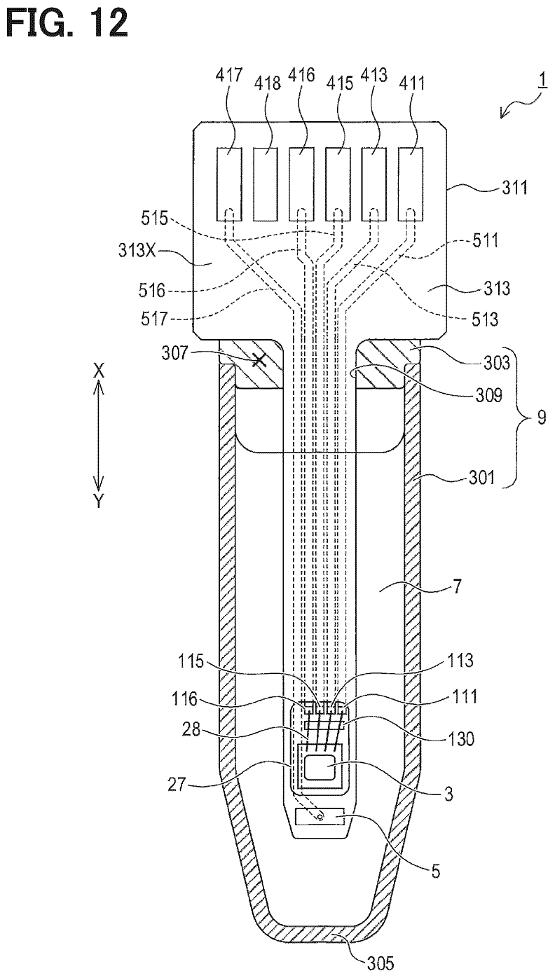

The ion sensor 1 of the third embodiment has the form shown in FIG. 12. The container 9 includes a main body 301 and a lid 303. The main body 301 has a bottomed tubular shape including a bottom portion 305. The main body 301 has an opening 307 on the side opposite to the bottom portion 305. An X direction is defined from the bottom portion 305 toward the opening 307. A direction opposite to the X direction is defined as a Y direction.

The lid 303 is a cylindrical member made of an elastic body such as rubber. The lid 303 is inserted into the opening 307. The opening 307 is closed by the lid 303. A notch 309 is formed in the lid 303. The notch 309 penetrates the lid 303 in the thickness direction of the lid 303. The solution 7 is contained in the container 9.

The ion sensor 1 includes an insertion member 311. The insertion member 311 includes a substrate 313, a sensor unit 3, a reference electrode 5, electrode portions 111, 113, 115, and 116, a protrusion 130, a bonding wire 28, and a protective member 27.

The substrate 313 is formed of a printed circuit board. The basic form of the substrate 313 is a belt-like form extending along the X direction and the Y direction. The substrate 313 has an X-side end portion 313X in the X direction, and the X-side end portion 313X is wider than the other portion. A portion of the substrate 313 other than the X-side end portion 313X passes through the notch 309 and is inserted into the container 9.

The sensor unit 3, the reference electrode 5, the electrode portions 111, 113, 115, and 116, the protrusion 130, the bonding wire 28, and the protective member 27 are provided in the vicinity of the end portion of the substrate 313 adjacent to the bottom portion 305. The sensor unit 3, the reference electrode 5, the protrusion 130, the bonding wire 28, and the protective member 27 in the third embodiment are the same as those in the second embodiment. The electrode portions 111, 113, 115, and 116 in the third embodiment are the same as the electrode portions 111X, 113X, 115X, and 116X in the second embodiment.

The sensor unit 3, the reference electrode 5, the electrode portions 111, 113, 115, and 116, the protrusion 130, the bonding wire 28, and the protective member 27 are disposed in the solution 7. Electrode portions 411, 413, 415, 416, 417, and 418 are formed on the surface of the X-side end portion 313X. Each of the electrode portions 411, 413, 415, 416, 417, and 418 is a metal thin film. Each of the electrode portions 411, 413, 415, 416, 417, and 418 has a rectangular shape.

Inner layer wirings 511, 513, 515, 516, and 517 are provided inside the substrate 313. The inner layer wirings 511, 513, 515, 516, and 517 pass through the inside of the substrate 313.

The electrode portion 411 is electrically connected to the electrode portion 111 by the inner layer wiring 511. The electrode portion 413 is electrically connected to the electrode portion 113 by the inner layer wiring 513. The electrode portion 415 is electrically connected to the electrode portion 115 by the inner layer wiring 515. The electrode portion 416 is electrically connected to the electrode portion 116 by the inner layer wiring 516. The electrode portion 417 is electrically connected to the reference electrode 5 by the inner layer wiring 517.

The electrode portions 411, 413, 415, 416, and 417 can output a signal of the ion sensor 1 to an external device.

### 2. Effects of Ion Sensor 1 and Method for Detecting Target Substance

According to the third embodiment described in detail, the effects (1A) to (1F) of the first embodiment and the effects (2A) to (2C) of the second embodiment are achieved.

### Other Embodiments

Although the embodiments of the present disclosure has been described above, the present disclosure is not limited to the embodiments, and various modifications can be made to implement the present disclosure.

(5-1) The ion sensor 1 may detect a target ion other than hydrogen ions. Also in this case, the effects of (1A) to (1F) and (2A) to (2C) can be achieved. For example, the material of the sensitive film of the ISFET can be made corresponding to a target ion to be detected.

(5-2) The reference electrode 5 may be an electrode other than the Ag/AgCl electrode. The reference electrode 5 may be, for example, a hydrogen electrode, a calomel electrode, or the like. Also in this case, the effects of (1A) to (1F) and (2A) to (2C) can be achieved.

(5-3) The container 9 may have an unsealed structure. For example, an inert gas may be continuously introduced into the container 9 by a gas introduction unit, and the inside of the container 9 may be set to an inert gas atmosphere. Also in this case, the effects of (1A) to (1F) and (2A) to (2C) can be achieved. The gas introduction unit can be configured using a known pump or the like.

(5-4) The solution 7 may not contain chloride ions. The reference electrode 5 may be a conventional Ag/AgCl electrode. Also in this case, the effects of (1A) to (1B), (1D) to (1F), and (2A) to (2C) can be achieved.

(5-5) The inert gas introduced into the container 9 may be a gas other than nitrogen gas. Examples of the gas other than the nitrogen gas include argon gas.

(5-6) The label 107 may be other than an enzyme.

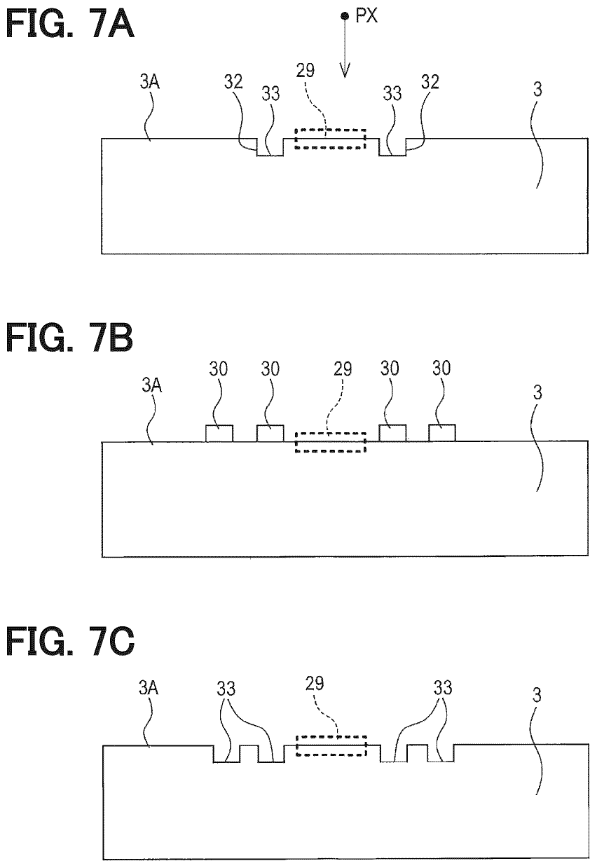

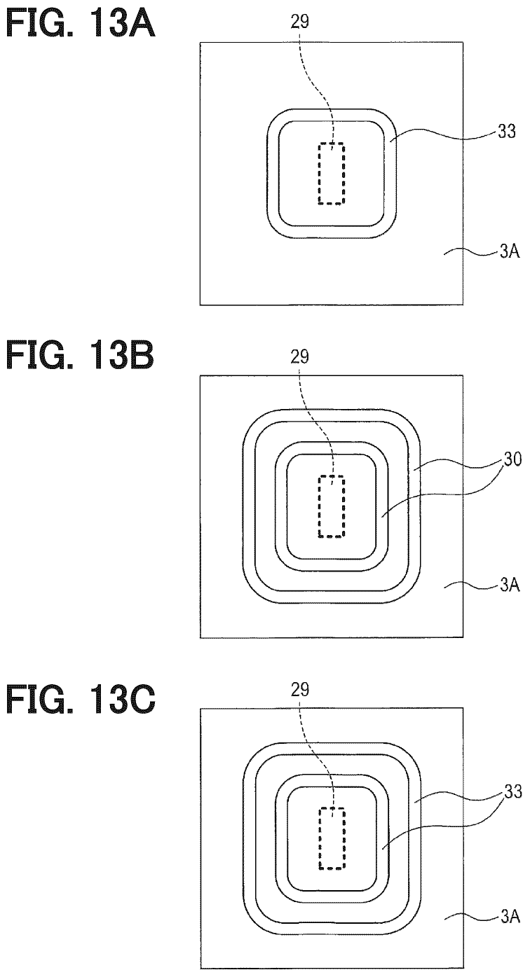

(5-7) As shown in FIGS. 7A and 13A, a groove 33 may be formed instead of the protrusion 30. The groove 33 is formed on the X-side surface 3A. As illustrated in FIG. 13A, when viewed from the viewpoint PX, the groove 33 is disposed so as to surround the periphery of the sensing area 29. When viewed from the viewpoint PX, the protective member 27 is positioned outside the groove 33. A part of the groove 33 is provided in a portion between the sensing area 29 and the protective member 27. The groove 33 has a recessed shape recessed from the X-side surface 3A around the groove 33. Therefore, a step 32 is formed between the groove 33 and the X-side surface 3A around the groove 33.

Even when the groove 33 is provided instead of the protrusion 30, the effect of (1E) can be obtained.

As shown in FIGS. 7B and 13B, the protrusion 30 may be formed in a double manner. In this case, the effect of (1E) is more remarkable. As shown in FIGS. 7C and 13C, the groove 33 may be formed in a double manner. In this case, the effect of (1E) is more remarkable. Note that the viewpoint PX illustrated in FIG. 7A is not illustrated in FIGS. 7B and 7C.

A groove may be formed instead of the protrusion 130. The protrusion 130 may be formed in a double manner, or the groove may be formed in a double manner.

(5-8) The sensor unit 3 may include a sensor other than the ISFET. Examples of the sensor other than the ISFET include a pH glass electrode.

(5-9) The target substance to be detected may be a virus other than SARS-CoV-2, a cell or a molecule such as a protein.

(5-10) The mounting of the ion sensor 1 is not limited to wire bonding. The ion sensor 1 may be mounted by, for example, a combination of a flip chip and an underfill agent. The ion sensor 1 may be mounted by WLP (Wafer level Packaging). Signal communication is also not limited to wired communication. The signal communication may be, for example, wireless communication such as NFC (Near field communication).

(5-11) An ion sensor system may be configured by combining plural ion sensors 1.

(5-12) The sensor unit 3 may be a chip in which plural sensors are arranged. The plural sensors include, for example, a temperature sensor.

(5-13) The ion sensor 1 may include a sensor different from the sensor unit 3 in the solution 7.

(5-14) One or both of the sensor unit 3 and the reference electrode 5 may be stored in the solution 7, then dried, and then used again.

(5-15) The ion sensor 1 may further include a signal processing circuit. The signal processing circuit and the sensor unit 3 can be integrated.

(5-16) The ion sensor 1 may estimate or correct the drift signal of the sensor unit 3 by signal processing.

(5-17) The ion sensor 1 may include a substance insoluble in the solution 7 in the container 9 instead of the inert gas. Examples of the substance that is insoluble in the solution 7 include oil.

(5-18) A pretreatment is performed before the target substance to be detected is introduced into the solution 7. Examples of the pretreatment include a treatment of binding the conjugate 103 to the target substance. The pretreatment can be performed by, for example, pipetting work by a human, automated processing by a robot, processing using a microchannel, or the like.

(5-19) A plurality of functions of one element in the above embodiment may be implemented by a plurality of elements. One function of one element may be implemented by a plurality of elements. Further, multiple functions of multiple elements may be implemented by one element, or one function implemented by multiple elements may be implemented by one element. A part of the configuration of the above embodiments may be omitted. At least part of the configuration of the above embodiment may be added to or replaced with the configuration of another embodiment described above.

(5-20) In addition to the ion sensor 1, the present disclosure may be implemented in various forms such as a system including the ion sensor 1 as a component.

What is claimed is:

1. An ion sensor comprising:
an ion detection element;
a reference electrode configured to provide a reference point of potential;
a solution in which an ion concentration is variable in a sensing area of the ion detection element; and
a container receiving the solution, wherein
the sensing area of the ion detection element is disposed in the solution,
at least a part of the reference electrode is disposed in the solution,
the solution contains an ion necessary for a redox reaction of the reference electrode, and
the container has an opening to introduce a target substance bound to a label having a function of changing an amount of ions detectable by the ion detection element into the solution.

2. The ion sensor according to claim 1, further comprising:
a resin in contact with a surface of the ion detection element, which is a contact portion of the ion detection element located away from the sensing area; and
a step provided on the surface of the ion detection element at location between the sensing area and the contact portion.

3. The ion sensor according to claim 1, further comprising:
a base material on which the ion detection element is attached by an adhesive;
an electrode portion provided on a surface of the base material to be electrically connected to the ion detection element; and
a step provided on the surface of the base material at location between the ion detection element and the electrode portion.

4. The ion sensor according to claim 3, wherein
the reference electrode is provided on a surface of the base material,
the ion detection element is positioned between the reference electrode and the electrode portion, and
the reference electrode is larger than the electrode portion.

5. The ion sensor according to claim 1, further comprising: a container receiving the solution, wherein the container is sealed.

6. The ion sensor according to claim 5, further comprising an inert gas in the container.

7. A method for detecting a target substance using an ion sensor including:
an ion detection element;
a reference electrode configured to provide a reference point of potential; and
a solution in which an ion concentration is variable in a sensing area of the ion detection element, wherein the method comprising:
disposing the sensing area of the ion detection element in the solution;
introducing the target substance bound to a label having a function of changing an amount of ions detectable by the ion sensor into the solution after the disposing; and
detecting a change in the amount of ions according to a concentration of the label using the ion sensor.


SEQUENCE LISTING (1 sequence)

SEQ ID NO: 1 - DNA, 51 bp, synthetic construct
  source 1..51: mol_type = other DNA
cagcaccgaccttgtgctttgggagtgctggtccaagggcgttaatggaca